(19) United States
(12) Patent Application Publication
(10) Pub. No.: US 2008/0291367 A1
(43) Pub. Date: Nov. 27, 2008

(54) Display device

(75) Inventors: Takayuki Ota, Ooamishirasato (JP); Kazuyoshi Tanaka, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/153,577

(22) Filed: May 21, 2008

(30) Foreign Application Priority Data
May 25, 2007 (JP) 2007-139189

(51) Int. Cl. G02F 1/1335

(52) U.S. Cl. 349/70

(57) ABSTRACT

A plurality of fluorescent tubes are retained at their end portions by a connector. A concave section is formed between insertion holes of the connector so that a slit section can be widened with ease, and the fluorescent tubes, fluorescent tube terminals, or others can be protected from any possible damage.

### CROSS-REFERENCE TO RELATED APPLICATION

The present application claims priority from Japanese application JP2007-139189 filed on May 25, 2007, the content of which is hereby incorporated by reference into this application.

### BACKGROUND OF THE INVENTION

1. Field of the Invention

The present invention relates to a liquid crystal display device and, more specifically, to a direct backlight and a liquid crystal display device using the backlight.

2. Description of the Related Art

The application of a liquid crystal display device has been extended to the field of large-sized display devices such as television receivers. The large-sized display devices are each often equipped with a backlight of direct type for achieving the brightness of a sufficient level. The light source of the backlight is mainly a fluorescent tube. As to the fluorescent tube, the longer the better in view of the larger screen size, and the smaller diameter the better in view of the light-emission efficiency. As such, a larger-screen liquid crystal display device is equipped with a plurality of long and narrow fluorescent tubes.

Such a long and narrow fluorescent tube is mechanically unstable, and thus an intermediate holder is provided at a middle portion between terminal sections supporting the fluorescent tube. However, this intermediate holder may affect the fluorescent tube in terms of light emission, thereby possibly causing uneven brightness of the backlight. To reduce the influence over such uneven brightness of the intermediate holder, Patent Document 1 (JP-A-2004-318176) has made an attempt, for example. Moreover, to ease the manufacturing of a direct backlight with some design ideas about the configuration thereof, Patent Document 2 (JP-A-2006-114445) has made an attempt, for example.

When a plurality of fluorescent tubes are used, the number of installation steps therefor becomes another problem. Because the fluorescent tubes are put under a high voltage, there is a risk of discharge between terminals of the fluorescent tubes. The technology for solving such a problem is exemplified by Patent Document 3 (JP-A-2006-253116).

### SUMMARY OF THE INVENTION

A liquid crystal display device is required to have a screen large in size with high-definition image quality. In order to implement such a high-definition screen, there needs to reduce the pixel size. In the liquid crystal display panel, however, such pixel size reduction causes a reduction of transmittance of light coming from a backlight. Also with a high-definition screen, the backlight is required to be high in intensity to keep any needed level of brightness. In order to increase the brightness of the backlight as such, there needs to increase the number of fluorescent tubes for installation because the intensity per fluorescent tube is limited. With a larger number of fluorescent tubes as such, installation with good efficiency and with safety becomes more important than ever. Moreover, installing a large number of fluorescent tubes in a fixed space resultantly reduces the creepage distance between terminals of the fluorescent tubes, thereby resulting in a severe problem of voltage resistance among the fluorescent tubes.

The present invention has the following features to solve the problems above.

A first aspect of the invention is directed to a liquid crystal display device including a liquid crystal display panel, and a backlight provided with a plurality of fluorescent tubes and a resin-made connector that keeps hold of the fluorescent tubes at an end portion thereof. In the display device, the connector is formed with insertion holes for keeping hold of the fluorescent tubes. The insertion holes are each closed at far end, and are each formed with a slit at an upper portion. The fluorescent tubes are each inserted from above the connector by widening the slit. Between any two of the insertion holes adjacent to each other, a side wall is formed, and the side wall is formed with a concave portion in an axial direction of the fluorescent tubes.

A second aspect of the invention is directed to a liquid crystal display device including a liquid crystal display panel, and a backlight provided with a plurality of fluorescent tubes and a resin-made connector that keeps hold of the fluorescent tubes at an end portion thereof. In the display device, the fluorescent tubes are each provided with a terminal protruding in an axial direction thereof, and a cable connected with the terminal in a direction perpendicular to the axial direction. The connector is formed with insertion holes for keeping hold of the fluorescent tubes. The insertion holes are each closed at the far end, and are each formed with a slit at an upper portion. The fluorescent tubes are each inserted from above of the connector by widening the slit, and the cable is being inserted into a cable hole drilled through the connector. Between any two of the insertion holes adjacent to each other, a side wall is formed, and the side wall is formed with a concave portion in the axial direction of the fluorescent tubes.

A third aspect of the invention is directed to a liquid crystal display device including a liquid crystal display panel, and a backlight provided with a plurality of fluorescent tubes and a resin-made connector that keeps hold of the fluorescent tubes at an end portion thereof. In the display device, the connector is formed with insertion holes for keeping hold of the fluorescent tubes, and the insertion holes are each closed at the far end, and are each formed with a slit at an upper portion. The fluorescent tubes are each inserted from above of the connector by widening the slit. Between any two of the insertion holes adjacent to each other, a side wall is formed, and the side wall is formed with a notch reaching an upper portion of the connector.

A fourth aspect of the invention is directed to a liquid crystal display device including a liquid crystal display panel, and a backlight provided with a plurality of fluorescent tubes and a connector that keeps hold of the fluorescent tubes at an end portion thereof. In the display device, the fluorescent tube includes a terminal protruding in an axial direction thereof, and a cable connected with the terminal in a direction perpendicular to the axial direction. The connector is formed with insertion holes for keeping hold of the fluorescent tubes. The insertion holes are each closed at the far end, and are each formed with a slit at an upper portion. The fluorescent tubes are each inserted from above of the connector by widening the slit, and the cable is inserted into a cable hole drilled through the connector. Between any two of the insertion holes adjacent to each other, a side wall is formed, and the side wall is formed with a notch reaching an upper portion of the connector.

According to the invention, at the time of installation of a fluorescent tube(s) to a connector that is provided for keeping hold of a plurality of fluorescent tubes, the risk of causing damages to the fluorescent tube(s) and a cable(s) for connection thereto can be small. This accordingly achieves installation of a large number of fluorescent tubes to a backlight with high reliability and with efficiency. Moreover, with the invention, the creepage distance between terminals of the fluorescent tubes can be increased, thereby favorably increasing the voltage resistance characteristics.

In the invention, a plurality of fluorescent tubes can be installed to a connector with safety, and by providing this connector plurally, a large number of fluorescent tubes can be installed to a backlight with ease. Moreover, with the excellent voltage resistance characteristics, even if the pitch among the fluorescent tubes is reduced as a result of the provision of a large number of fluorescent tubes, the reliability can remain high. This is considered especially effective to displays for medical use required to be of high-definition.

### DESCRIPTION OF THE DRAWINGS

FIG. 1 is a general view of a liquid crystal display device;

FIG. 2 is an exploded perspective view of a backlight;

FIG. 3 is a plan view of a lower frame for housing therein fluorescent tubes;

FIG. 4 is a cross-sectional view of the lower frame cut along a line A-A of FIG. 3;

FIG. 5 is a plan view of the lower frame with the fluorescent tubes housed therein;

FIG. 6 is a perspective view of an intermediate holder viewed from above;

FIG. 7 is another perspective view of the intermediate holder viewed from the bottom;

FIG. 8 is a cross-sectional view of the intermediate holder being mounted to the lower frame;

FIG. 9 is a plan view of the fluorescent tubes being supported by a connector and the intermediate holder;

FIG. 10 is a cross-sectional view of a fluorescent tube being supported by the intermediate holder;

FIG. 11 is a perspective view of a connector of a first embodiment;

FIG. 12 is a perspective view of the connector of the first embodiment viewed from the rear surface thereof;

FIGS. 13A to 13D are each a view of the connector of the first embodiment with the trigonometry;

FIG. 14 is a conceptual view of the fluorescent tubes being inserted into the connector;

FIG. 15 is a conceptual cross-sectional view of a fluorescent tube after being inserted into the connector;

FIG. 16 is a conceptual perspective view of a fluorescent tube being inserted into the connector;

FIG. 17 is a perspective view of fluorescent tubes after being inserted into the connector;

FIGS. 18A and 18B are each a view of the fluorescent tubes of FIG. 17 with the trigonometry;

FIG. 19 is a conceptual view of the connector keeping hold of a piece of fluorescent tube;

FIG. 20 is a conceptual view of the connector keeping hold of two pieces of fluorescent tubes;

FIG. 21 is a conceptual view of the connector keeping hold of three pieces of fluorescent tubes;

FIG. 22 is a comparison example of the first embodiment;

FIG. 23 is a conceptual view of a connector of the comparison example keeping hold of two pieces of fluorescent tubes;

FIG. 24 is a conceptual view of the connector of the comparison example keeping hold of three pieces of fluorescent tubes;

FIG. 25 is a perspective view of a connector of a second embodiment;

FIG. 26 is a conceptual view of the connector of the second embodiment keeping hold of two pieces of fluorescent tubes; and

FIG. 27 is a conceptual view of the connector of the second embodiment keeping hold of three pieces of fluorescent tubes.

### DESCRIPTION OF THE PREFERRED EMBODIMENTS

The invention is described in detail by way of embodiments.

### First Embodiment

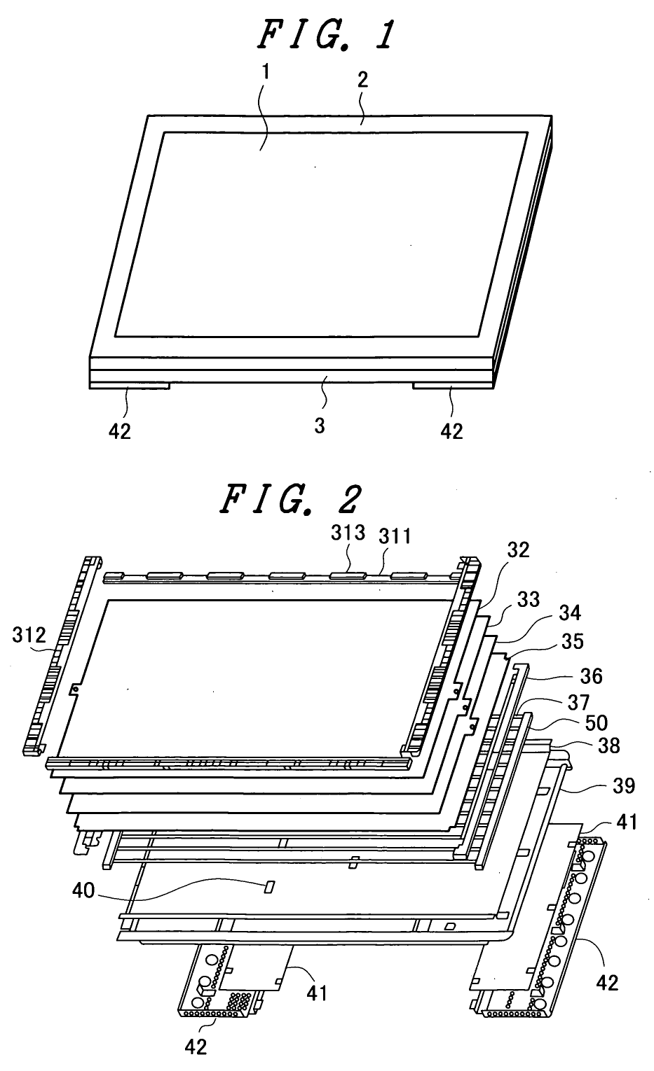

FIG. 1 is a general view of a liquid crystal display device. A frame-shaped front frame 2 carries therein a liquid crystal display panel 1. The liquid crystal display panel 1 is configured to include a TFT (Thin-Film Transistor) substrate, an opposing substrate, and upper and lower polarization plates. The TFT substrate is formed thereon with image signal lines, scan lines, pixel electrodes, thin-film transistors, and others. The opposing substrate is formed with a color filter substrate, for example. The upper polarization plate is affixed to the opposing substrate, and the lower polarization plate is affixed to the TFT substrate. Such a liquid crystal display panel 1 is covered by the front frame 2, and in the liquid crystal display panel 1 of FIG. 1, the display screen thereof is only visible.

At the rear of the liquid crystal display panel 1, a backlight 3 is installed. Lights from this backlight 3 are switched on and off on a pixel basis by the liquid crystal display panel 1 so that images are formed. For extracting lights toward the liquid crystal display panel 1 with efficiency, the backlight 3 is configured by a light source such as fluorescent tube, and various many optical components. The light source of the backlight 3, i.e., a fluorescent tube 37, is driven at a high frequency by an inverter for prevention of flickering. This inverter is housed in an inverter box 42 of FIG. 1.

FIG. 2 is an exploded perspective view of a portion of the backlight. The backlight is of a so-called direct backlight, which is often used in a large-sized display device such as television receiver. The liquid crystal panel is placed on a mold frame, which is configured to include a long-side mold frame 313 and a short-side mold frame 312. This configuration is for increasing the material yield.

On this mold frame, the liquid crystal display panel 1 is to be placed. Around the liquid crystal display panel (not shown), an IC driver and a flexible wiring substrate are disposed for driving the liquid crystal display panel. The flexible wiring substrate is disposed after being bent toward the rear for reducing the outer size of the liquid crystal display device. To accept such a flexible wiring substrate, the mold frame is formed with a flexible wiring substrate receiver 313.

In the mold frame, three diffusion sheets 32, 33, and 34 are so disposed as to oppose the rear surface of the liquid crystal display panel 1. The diffusion sheets 32, 33, and 34 each serve to diffuse lights coming from the light source, and to provide uniform lights to the liquid crystal display panel 1. The diffusion sheets 32, 33, and 34 are each generally formed with projections or depressions on the surface, thereby achieving the effects of light-gathering. For such effects of light-gathering, three diffusion sheets are in use. These diffusion sheets in use each have the thickness of about 0.2 mm.

Below the diffusion sheet 34, a diffusion plate 35 is disposed. The diffusion plate 35 serves to make uniform lights coming from the light source, i.e., the fluorescent tube 37, and to direct the resulting uniform lights toward the liquid crystal display panel 1. The diffusion plate 35 has the thickness of 1 mm. This diffusion plate 35 is disposed to a side mold 36.

Below the side mold 36, a plurality of fluorescent tubes 37 serving as a light source are disposed. The amount of lights from this light source 37 directly affects the brightness of the screen. With a 32-inch television receiver, for example, 16 fluorescent tubes 37 are generally used. With a high-definition display, a larger number of fluorescent tubes 37 are used. For placement of such a large number of fluorescent tubes 37 with a small pitch, a connector 50 being the characteristics of the invention is used in this embodiment. In FIG. 2, the connector 50 looks like a piece, but actually, the connector 50 is plurally disposed in parallel for keeping hold of a large number of fluorescent tubes 37. The fluorescent tubes 37 to which the invention is applicable are disposed to a lower frame 39. For directing the lights from the fluorescent tubes 37 as much as possible to the side of the liquid crystal display panel 1, a reflection sheet 38 is disposed between the lower frame 39 and the fluorescent tubes 37.

With a larger screen, the fluorescent tube 37 is increased in length. On the other hand, because the fluorescent tube 37 shows the better light-emission efficiency with a smaller tube diameter, the fluorescent tube 37 for use with a liquid crystal backlight will be narrow and long. In this embodiment, the fluorescent tube 37 has the length of 790 mm, and has the diameter of 3 mm. For the purpose of increasing the efficiency, the fluorescent tube with a diameter of 2 mm is sometimes used. As such a narrow fluorescent tube, a CCFL (Cold Cathode Fluorescent Lamp) is often used. For the purpose of preventing movement of the fluorescent tubes 37 due to vibration or preventing any possible damage thereof, an intermediate holder 40 made of a resin is provided. FIG. 2 shows only the approximate position for attachment of the intermediate holder. This intermediate holder 40 is attached to the lower frame 39 via the reflection sheet 38.

The fluorescent tubes 37 are driven by an inverter. The inverter is attached to an inverter substrate 41, which is disposed on the underside of the lower frame 39. This inverter is protected by an inverter cover 42.

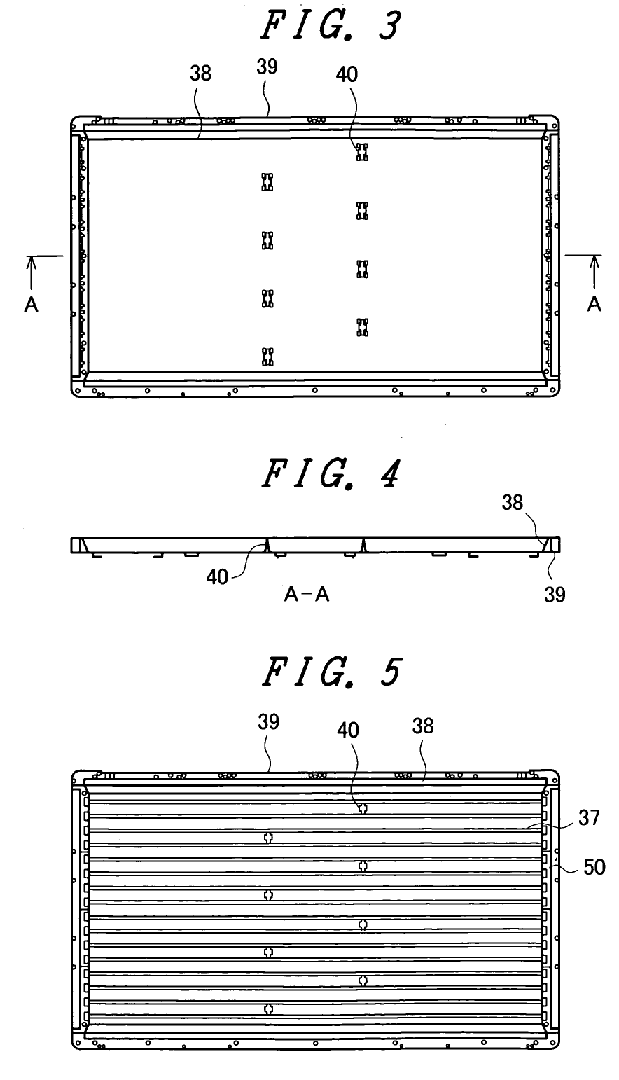

FIG. 3 is a plan view of the lower frame 39 being attached with the reflection sheet 38 and the intermediate holder 40. For avoiding the complexity, FIG. 3 shows a case where the number of fluorescent tubes 37 in use is 16. With a high-definition display, the number of fluorescent tubes 37 in use is twice of 16, i.e., 32, but the placement thereof looks the same as that in FIG. 3. FIG. 4 is a cross-sectional view of the lower frame 39 cut across a line A-A of FIG. 3. The reflection sheet 38 is disposed like a gutter in the lower frame 39. The intermediate holder 40 is disposed in two rows in a staggered configuration, i.e., eight holders in total. Each of the intermediate holders 40 keeps hold of two pieces of fluorescent tubes 37.

FIG. 5 shows the state in which the lower frame 39 is attached with the fluorescent tubes 37. The fluorescent tubes 37 are driven by the inverter. The fluorescent tubes 37 are inserted into each of the connectors 50 on the basis of a group of four. Four connectors 50 are disposed in line on the short sides of the lower frame, thereby keeping hold of 16 fluorescent tubes 37. The number of the fluorescent tubes 37 to be retained by a piece of holder is not restrictive to four, and various other cases will do. In this invention, because a large number of fluorescent tubes 37 are provided to the backlight, each holder keeps hold of a plurality of fluorescent tubes 37.

In FIG. 5, one intermediate holder 40 keeps hold of two pieces of fluorescent tubes 37. The number of the fluorescent tubes 37 to be retained by the intermediate holder is not restrictive to two, and various other numbers will do. If the number is made the same as the number of the fluorescent tubes 37 to be retained by the connector 50, any possible installation error can be prevented during installation work of the fluorescent tubes 37.

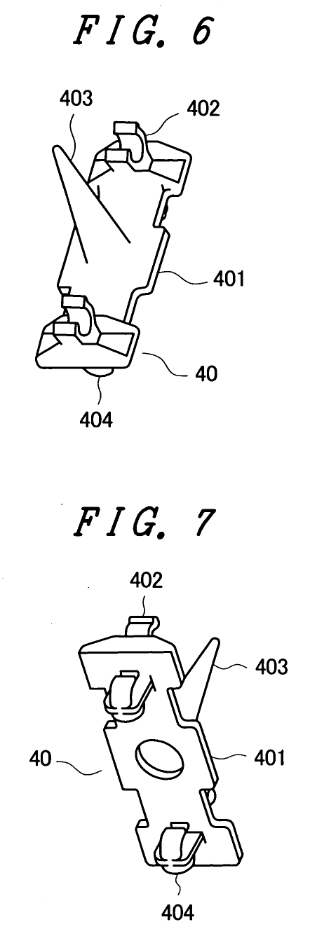

FIG. 6 is a perspective view of the intermediate holder 40 viewed from the front side. The intermediate holder 40 is configured to include a bottom section 401, a fluorescent tube retention section 402, and a spacer section 403. The fluorescent tube retention section 402 is set with the fluorescent tubes 37, thereby keeping hold of the fluorescent tubes 37. As will be described later, the spacer section 403 is provided for keeping the space between the fluorescent tubes 37 and the diffusion plate 35. FIG. 7 is a perspective view of the intermediate holder 40 viewed from the under-side thereof. An attachment section 404 is provided for attaching the intermediate holder 40 to the lower frame 39. The intermediate holder 40 is made of polycarbonate.

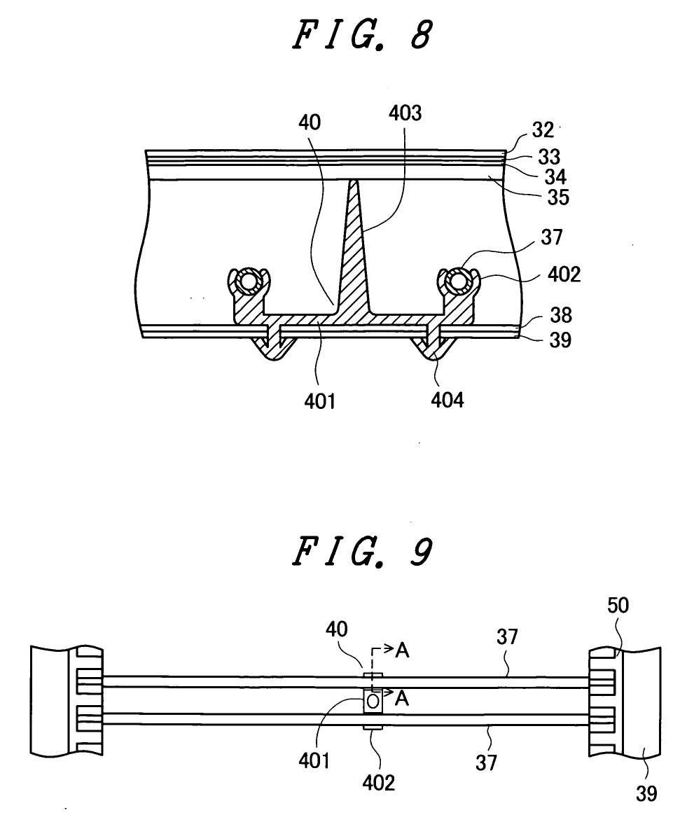

FIG. 8 shows the intermediate holder 40 keeping hold of the fluorescent tubes 37 by being attached to the lower frame 39. The intermediate holder 40 is attached to the lower frame 39 by the attachment section 404. The fluorescent tube retention section 402 serves to keep hold of the fluorescent tubes 37. The spacer section 403 serves to keep constant the space between the reflection sheet 38 attached to the lower frame 39 and the diffusion plate 35, or the space between the fluorescent tubes 37 and the diffusion plate 35. Because the diffusion plate 35 is made thin as 1 mm, when the display screen is increased in size, the diffusion plate 35 will be deformed, and thus the space from the fluorescent tubes 37 or others is reduced in the area closer to the center of the screen. Because the diffusion plate 35 is not deformed uniformly, such uneven deformation affects the backlight as an intensity variation. The spacer section 403 of the intermediate holder 40 serves to keep constant the distance between the diffusion plate 35 and the fluorescent tubes 37, for example, thereby serving well to suppress the intensity variation.

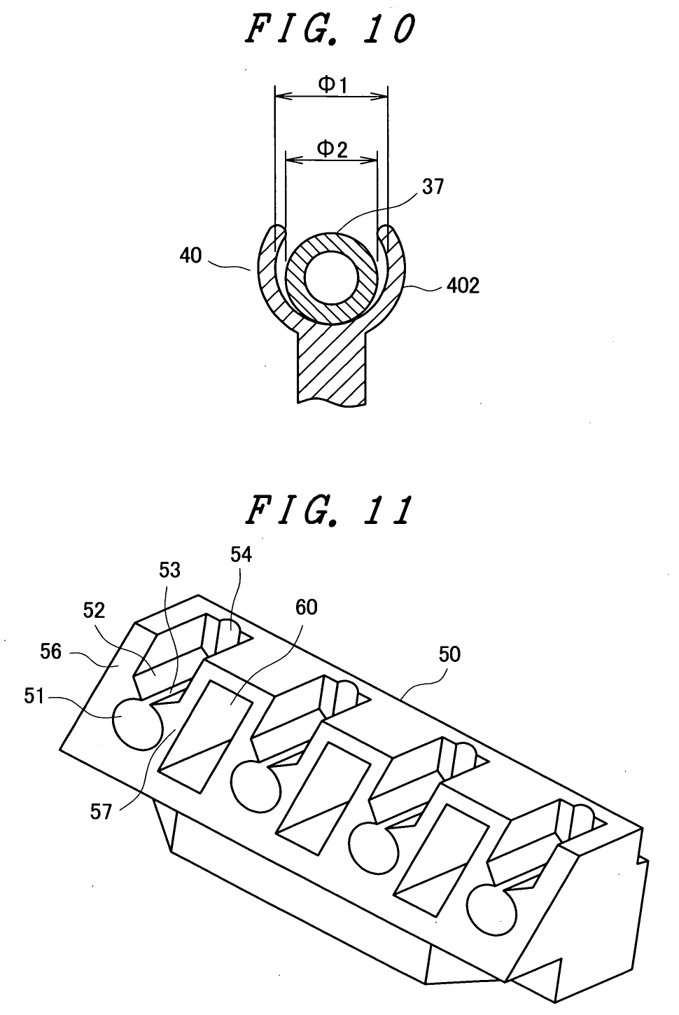

FIG. 9 is a schematic diagram specifically showing a piece of intermediate holder 40 keeping hold of two pieces of fluorescent tubes 37. FIG. 10 shows a partial cross-sectional view of the intermediate holder 40 cut across a line A-A of FIG. 9. FIGS. 9 and 10 both do not show details. FIG. 10 shows the relationship between the fluorescent tubes 37 and the retention section of the intermediate holder 40. The fluorescent tubes 37 each have the diameter φ2 of 3 mm with the variation of about 0.1 mm. The internal diameter of the retention section 402 of the intermediate holder 40 varies also about 0.1 mm. As a result, the internal diameter φ1 of the retention section 402 of the intermediate holder 40 is about 3.2 mm.

FIG. 11 is a perspective view of the connector 50 in use in the embodiment. The connector 50 is made of silicone rubber. The connector 50 is not restrictively made of silicon rubber, but may be made of any material, especially a resin, as long as it has a sufficient level of elasticity. In FIG. 11, an insertion hole 51 is inserted with the fluorescent tube 37 for retention. Each connector 50 takes charge of four fluorescent tubes 37. The fluorescent tubes 37 are each inserted from above of the insertion hole 51 by widening the slot of a tongue-like section 52. At the rear of the connectors 50, a cable guide section 54 is formed with a semicircular cross-section for guiding a cable 70, which is connected to each of the fluorescent tubes 37. Between the insertion holes 51 and 51, a square-shaped concave section 60 is formed.

For insertion of the fluorescent tubes 37 into the connector 50, a slit 53 between the two opposing tongue-like sections 52 is widened, thereby requiring outer and inner walls 56 and 57 of the connector 50 to be easily deformed. The outer wall 56 is thin, and thus is easily deformed. The inner wall 57 can be also easily deformed as is formed with the square-shaped concave section 60. Accordingly, without damaging the fluorescent tubes 37, fluorescent tube terminals 371, and others, the fluorescent tubes 37 can be inserted into the connectors 50.

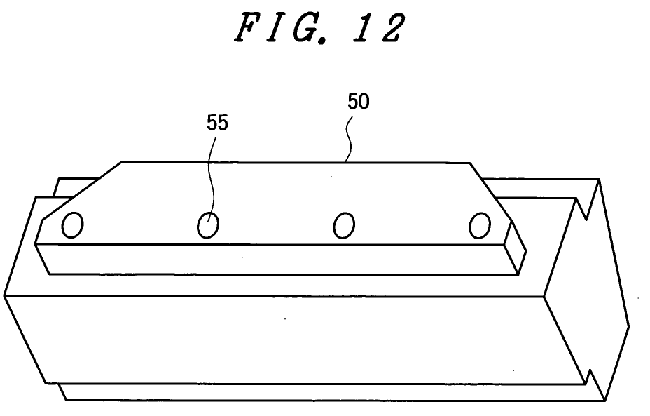

FIG. 12 is a perspective view of the connector 50 viewed from the underside thereof. In FIG. 12, the connector 50 is formed with, on its lower surface, a cable hole 55 for insertion of the cable 70 after being connected to the fluorescent tube 37. The lower portion of the connector 50 is partially cut out, and this cut-out is used as a guide for placement of an optical sheet or a reflection sheet of the backlight, for example.

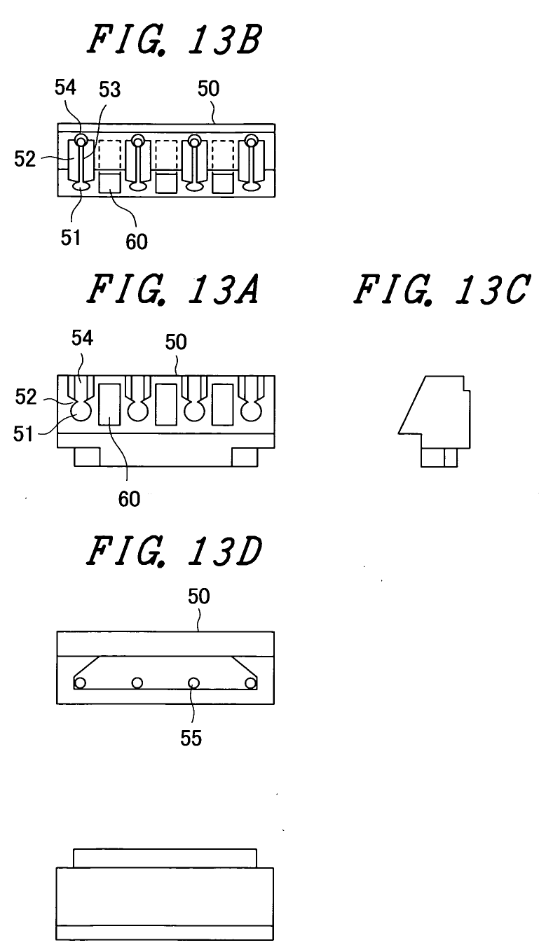

FIGS. 13A to 13D are each a projection diagram with the trigonometry of the connector 50. FIG. 13A is a front view of the connector 50, FIG. 13B is a plan view thereof, FIG. 13C is a side view thereof, and FIG. 13D is a bottom view thereof. FIG. 13B shows the depth of the concave section 60 formed to the connector 50. In view of achieving easy deformation of the internal wall 57 in the tongue-like section 52, the concave section 60 is preferably formed with a depth. That is, as shown in FIG. 13B, the concave section 60 has the depth equal to or deeper than the slit section in the length direction. Alternatively, the concave section 60 preferably has the depth equal to or deeper than the area where the tongue-like section 52 is formed. The connector 50 is shaped like a trapezoid in its entirety when viewed from the side, and the connector 50 looks a little complicated when viewed from the front and above, for example. The reason of the connector 50 being shaped like a trapezoid in its entirety is to ease insertion of the fluorescent tubes 37 from above of the connector 50. The connector 50 is also formed with various cut-outs at the bottom portion to make those available for use as guides for the optical sheet, the reflection sheet, and others.

Such a connector 50 is plurally disposed in line to the lower frame, thereby keeping hold of a large number of fluorescent tubes 37. For example, if with 16 fluorescent tubes 37, four connectors 50 are used, and if with 32 fluorescent tubes 37, eight connectors 50 are used. Needless to say, with screens of the same size, the larger number of fluorescent tubes 37 reduces the pitch of the insertion holes 51 and 51 for the fluorescent tubes 37, thereby reducing the diameter of each of the connectors 50.

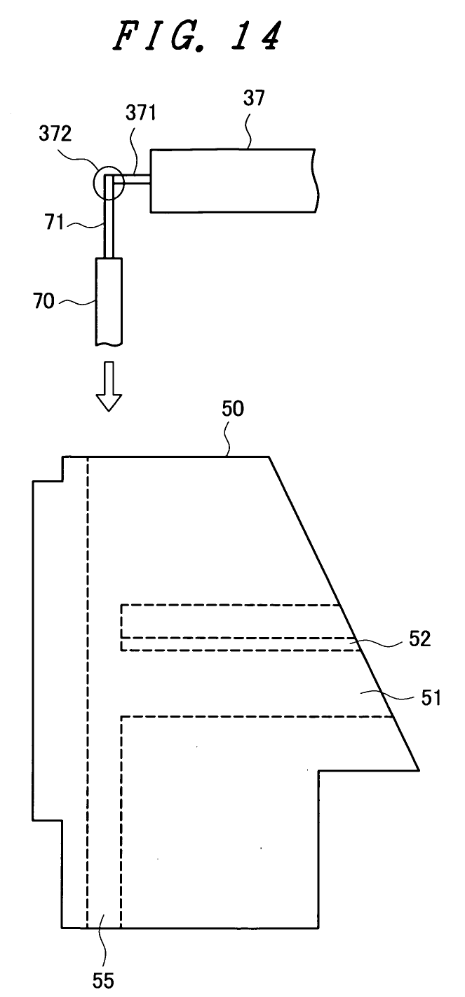

FIG. 14 is a schematic diagram showing the connector 50 being inserted with the fluorescent tube 37. In FIG. 14, from the fluorescent tube 37, the fluorescent tube terminal 371 is extended. In a direction perpendicular to the fluorescent tube terminal 371, an electric wire 71 of the cable 70 is soldered. Connecting the cable 70 in the direction perpendicular to the fluorescent tube terminal 371 is considered important in view of reducing the outer size of the display device. The fluorescent tubes 37 and the cable 70 are inserted into the connector 50 from above of the connector 50. The cable 70 is inserted into the cable hole 55 of the connector 50, and then is extended to the lower portion of the connector 50. The fluorescent tube 37 widens the tongue-like section 52 of the connector 50, and is then inserted into the insertion hole 51.

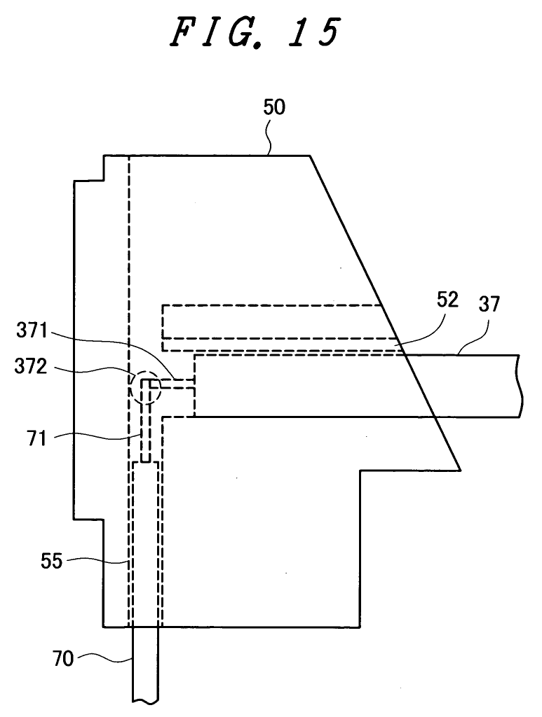

FIG. 15 shows the fluorescent tube 37 being inserted into the connector as such. As shown in FIG. 15, with the configuration that the fluorescent tube 37 and the cable 70 are disposed to be perpendicular to each other, the space of the terminal section of the fluorescent tube 37 can be favorably saved. Moreover, with the configuration that a connection section 372 between the fluorescent tube terminal 371 and the electric wire 71 is located inside of the connector 50, any possible danger of discharge with the adjacent fluorescent tube 37 can be prevented. Moreover, the creepage distance from the connection section with the adjacent fluorescent tube 37 can be increased, and also in this respect, any danger of discharge can be successfully prevented. For information, the fluorescent tubes 37 are put under the voltage of 1200 V during operation, and under the voltage of about 1600 V at the time of activation. Therefore, the connector section is required to be voltage resistant of 2000 V at the minimum.

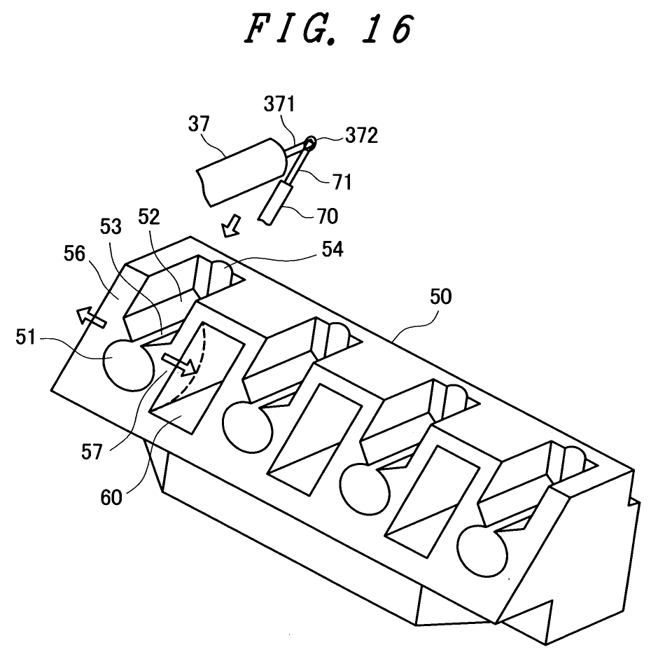

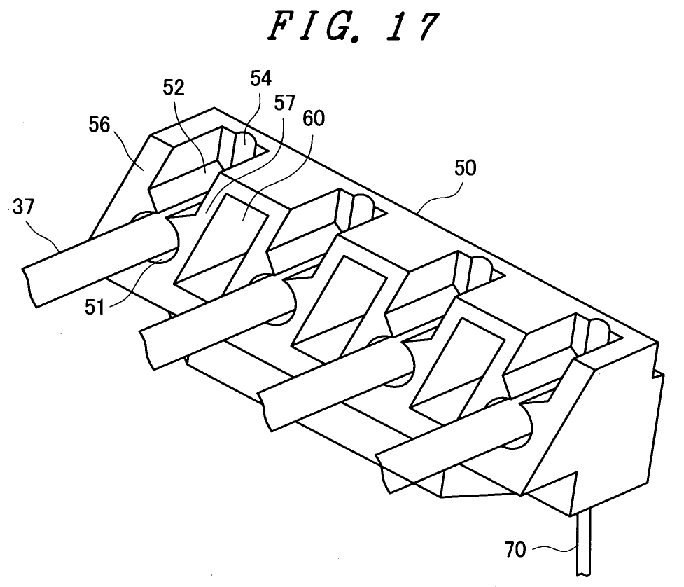

FIG. 16 is a perspective view of the connector 50 being inserted with the fluorescent tube 37. The fluorescent tube 37 and the cable 70 are inserted into the connector 50 from the direction of an arrow A. The cable 70 is inserted into the cable hole 55 (not shown) formed to the lower portion of the connector after going through the cable guide section 54. The fluorescent tube 37 widens the tongue-like section 52 in the directions of arrows B and C, i.e., toward outside, and then is inserted into the insertion hole 51 through the resulting widened slit 53. In this case, because the connector 50 is formed with the concave section 60, the internal wall can be also easily elastically deformed as indicated by a dotted line, thereby allowing insertion of the fluorescent tube 37 without damaging the fluorescent tube 37 or the cable, for example. FIG. 16 shows only the left end of the connector 50, but the insertion section looks similar thereto.

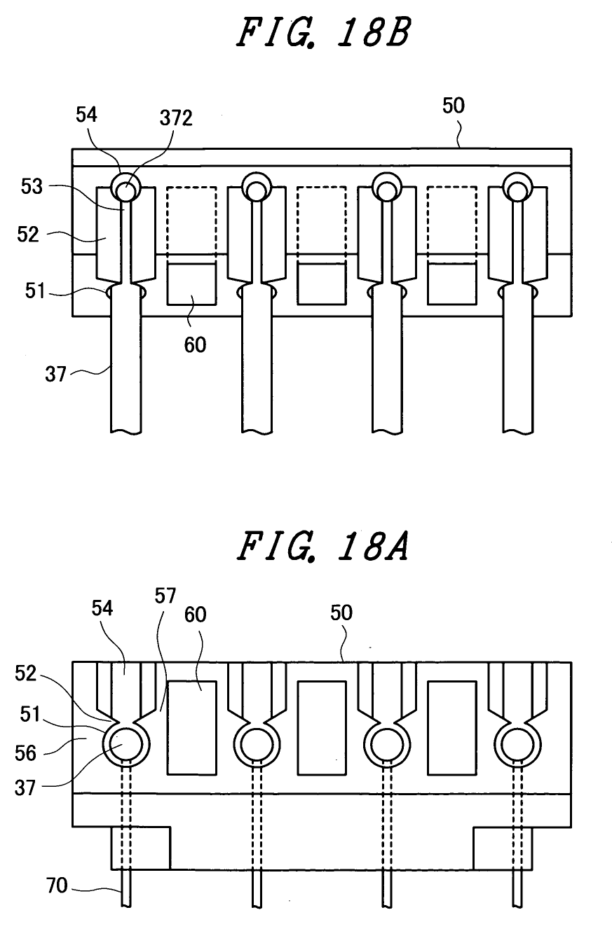

FIG. 17 shows the connector 50 being inserted with four pieces of fluorescent tubes 37 and the cables. Because the silicone rubber has excellent elasticity, the tongue-like sections 52 are back in shape after the insertion of the fluorescent tubes thereinto, thereby covering the fluorescent tubes 37 from above for retention inside of the connector. FIGS. 18A and 18B show, with the trigonometry, the fluorescent tubes 37 being inserted into the connector 50. FIG. 18A is a front view, and FIG. 18B is a plan view. FIG. 18A shows a state in which the fluorescent tubes 37 are retained in the insertion sections of the connector 50, and the cables connected with the fluorescent tubes 37 are extended to the lower portion of the connector 50 via the cable holes 55 (not shown). FIG. 18B shows the fluorescent tubes 37 being covered from above by the tongue-like sections 52 of the connector 50. FIG. 18B also shows the terminals of the fluorescent tubes 37 and soldering sections 372 of the cables through the cable guide sections 54.

As such, in this embodiment, without damaging the fluorescent tubes 37 and the cables, the connector 50 is allowed to keep hold of the fluorescent tubes 37 with efficiency. Also in this embodiment, with the configuration that the fluorescent tubes 37 and the cables are connected perpendicular to each other, the outer size of the display device can be suppressed small. Moreover, in this embodiment, the creepage distance can be increased between the terminals of the fluorescent tubes 37, thereby being able to increase the voltage resistance.

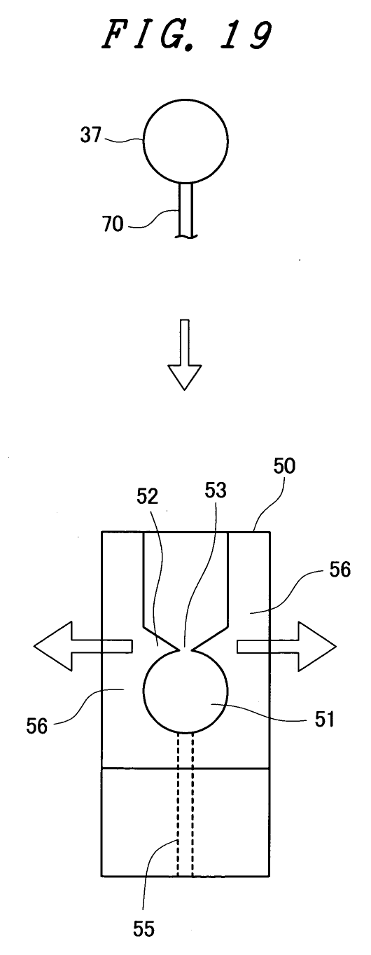

FIGS. 19 to 21 are each a schematic diagram for illustrating the effects of the concave section 60 formed to the connector 50 of the invention. FIG. 19 shows the connector 50 being inserted with a piece of fluorescent tube 37. In FIG. 19, when the fluorescent tube 37 is inserted into the connector 50, the wall of the connector 50 is widened to both sides as indicated by arrows so that the slit 53 is widened for insertion of the fluorescent tube 37. As shown in FIG. 19, when the connector 50 keeps hold of a piece of fluorescent tube 37, the tongue-like section 52 can be widened to the outside because the wall of the connector 50 is made thin. However, with such a configuration that the connector 50 keeps hold of a piece of fluorescent tube 37, the retention configuration is complicated and this is not considered advantageous in view of the number of assembly steps.

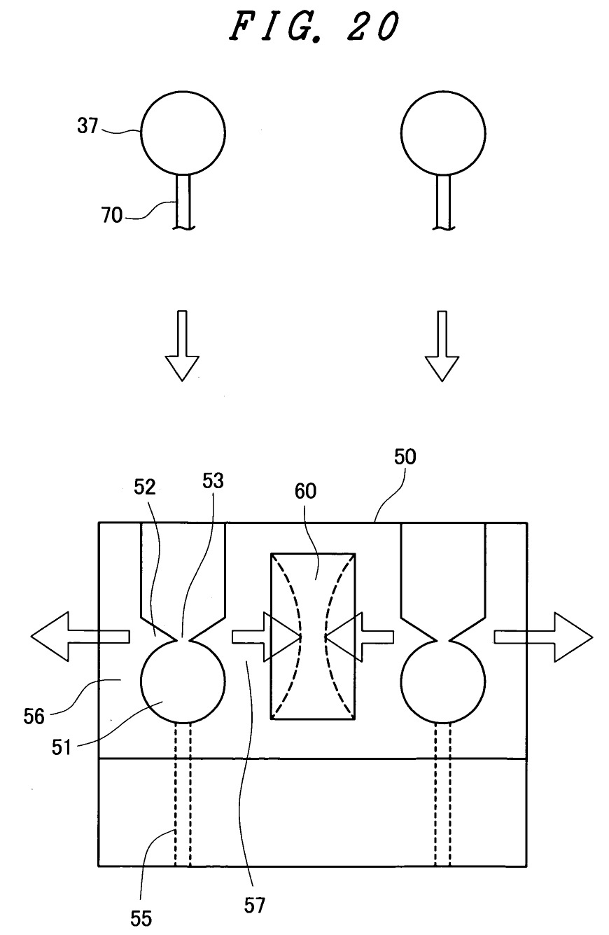

FIG. 20 shows a case where a piece of connector 50 keeps hold of two pieces of fluorescent tubes 37. Also in FIG. 20, for insertion of the fluorescent tubes 37 to the connector 50, widening the tongue-like sections 52 toward the outside as indicated by arrows is the same. In FIG. 20, because the square-shaped concave section 60 is formed between the two insertion holes 51 and 51, the inner side walls can be deformed with ease as indicated by dotted lines so that the fluorescent tubes 37 can be inserted into the connector 50 with no need to apply a large stress to the fluorescent tubes 37 or the cables.

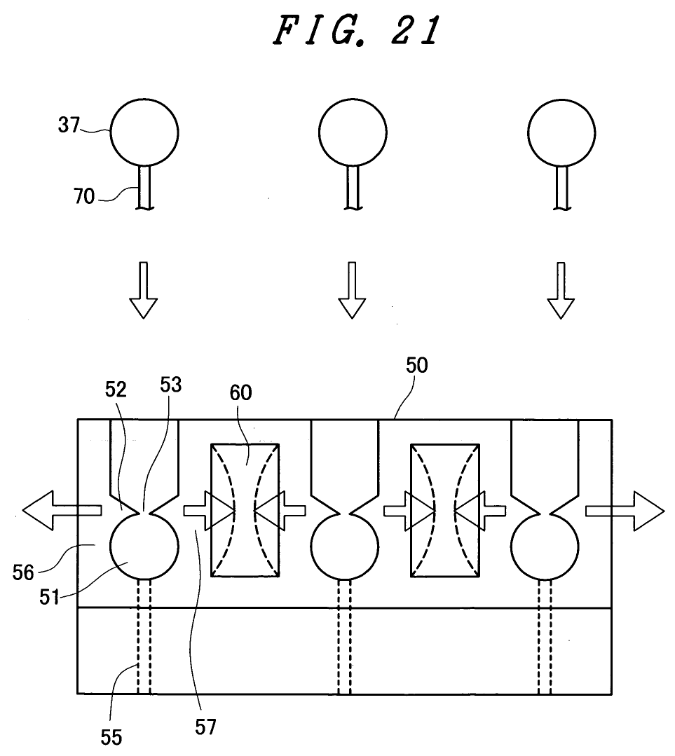

FIG. 21 shows a case where a piece of connector 50 keeps hold of three pieces of fluorescent tubes 37. Also in this case, because the square-shaped concave section 60 is formed between the two insertion holes 51 and 51, the inner side walls can be deformed with ease as indicated by dotted lines by the force in the direction of arrows so that the fluorescent tubes 37 can be inserted into the connector 50 with no need to apply a large stress to the fluorescent tubes 37 or the cables. This is also applicable to a case of keeping hold of four or more pieces of fluorescent tubes 37 by the connector 50. In such cases, the concave section 60 formed between the insertion holes 51 and 51 of the connector 50 is exemplified as being in the square shape, but the square shape is surely not the only option. Even if the concave section 60 is alternatively in the oval shape, the same effects can be achieved as the concave section 60 is in the square shape. That is, as shown in FIG. 21, for example, for insertion of the fluorescent tubes 37 into the connector 50, the concave section 60 serves well as long as it can deform the inner side portions of the connectors 50 with ease.

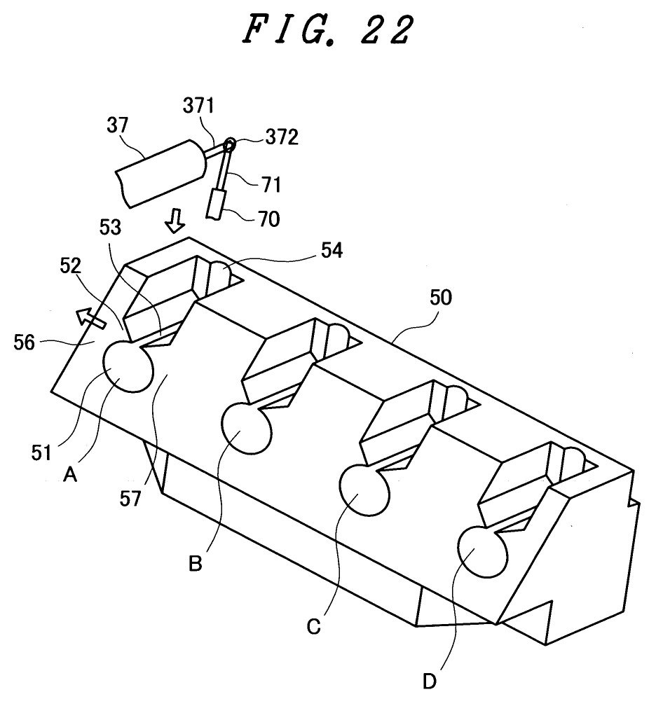

FIG. 22 shows the connector 50 in a comparison example. With the connector 50 in FIG. 22, the square-shaped concave section 60 is not formed between the insertion holes 51 and 51. FIG. 22 shows an exemplary case of keeping hold of four pieces of fluorescent tubes 37 by a piece of connector 50. As shown in FIG. 22, for insertion of the fluorescent tube 37 into an insertion hole A, D, or others formed at the end portion of the connector 50, as indicated in the vicinity of the insertion hole A, the outer portion of the connector is deformed as indicated by arrows, thereby easing insertion of the fluorescent tube 37. On the other hand, for insertion of the fluorescent tube 37 into the insertion hole 51 formed inside of the connector 50, because the internal wall 57 is formed thick and thus is hardly deformed, inserting the fluorescent tube 37 into the insertion hole 51 of the connector 50 is not that easy.

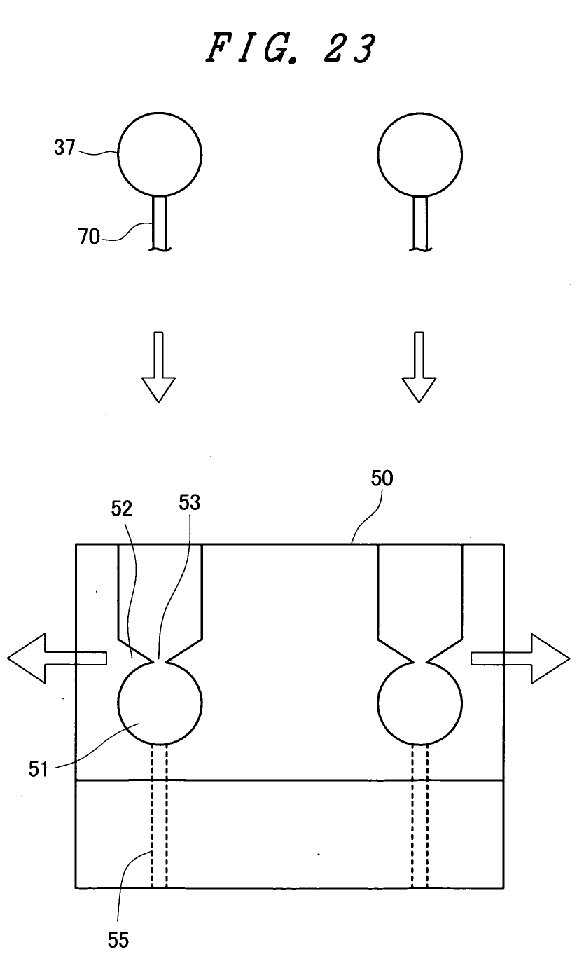

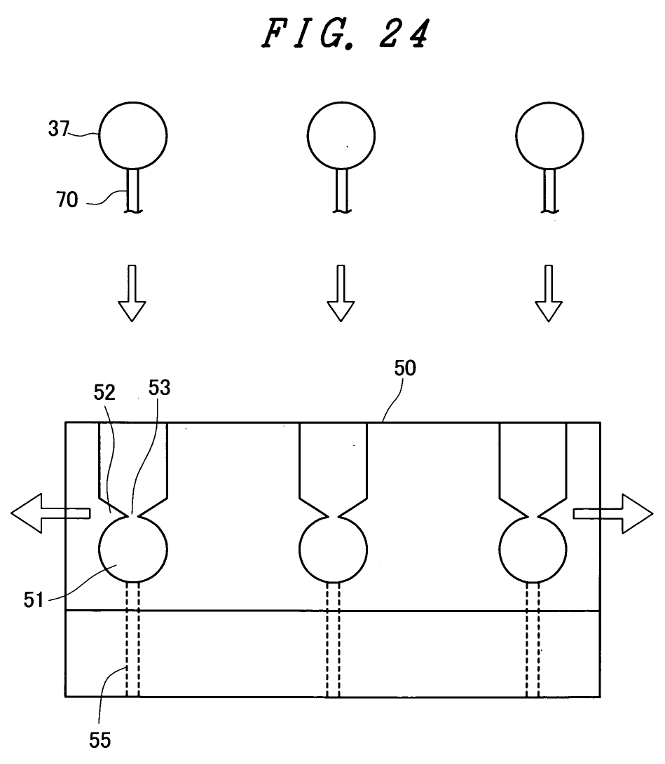

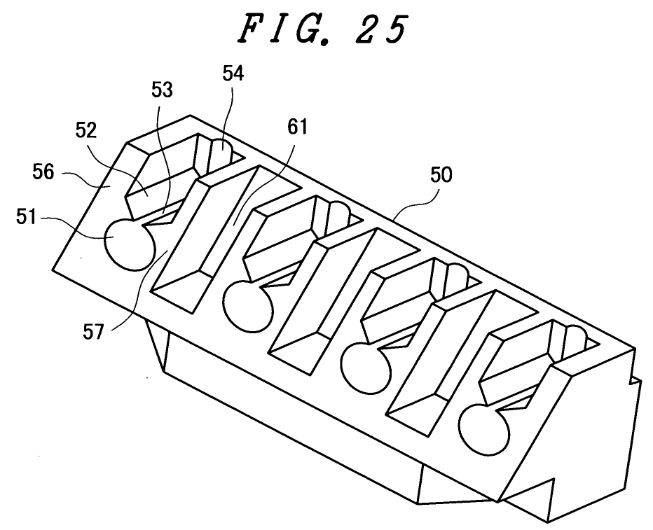

FIG. 23 shows a case where a piece of connector 50 keeps hold of two pieces of fluorescent tubes 37. In FIG. 23, the outer walls 56 of the connector 50 are deformed as are moved as indicated by arrows, and thus insertion of the fluorescent tubes 37 is not difficult that much. FIG. 24 shows a case where a piece of connector 50 keeps hold of three pieces of fluorescent tubes 37. In FIG. 24, for insertion of the fluorescent tubes 37 to the insertion holes 51 located at the end portions of the connector, their tongue-like sections 52 located on the outer sides can be each widened with ease in the direction of arrows, and thus insertion of the fluorescent tubes 37 is not difficult that much. However, for insertion of the fluorescent tube 37 into the insertion hole 51 located in the middle, because the side walls on both sides are thick and thus are hardly deformed, insertion of the fluorescent tube 37 is not that easy.

### Second Embodiment

FIG. 25 shows the connector 50 of a second embodiment of the invention. In FIG. 25, between the insertion holes 51 and 51 of the fluorescent tubes 37, a notch 61 is formed as an alternative to the concave section 60. That is, in the connector 50 of this embodiment, the connector 50 for use with a piece of fluorescent tube is so configured as to be connected by the bottom and rear surface sections. With such a configuration of this embodiment, compared with the first embodiment, the internal wall 57 between the insertion holes 51 and 51 can be reduced in strength to a further degree. Accordingly, insertion of the fluorescent tubes 37 can be eased to a further extent, thereby being able to reduce the stress to a further degree with respect to the fluorescent tubes 37 and the cables at the time of insertion.

On the other hand, because the internal wall 57 is interposed between the insertion holes 51 and 51 of the connector 50 for the fluorescent tubes 37, the creepage distance between the terminals of the fluorescent tubes 37 can be large enough as in the first embodiment, and there thus is no problem in view of voltage resistance. The connector 50 of this embodiment is configured similar to that of the first embodiment except that the notch 61 is interposed between the insertion holes 51 and 51.

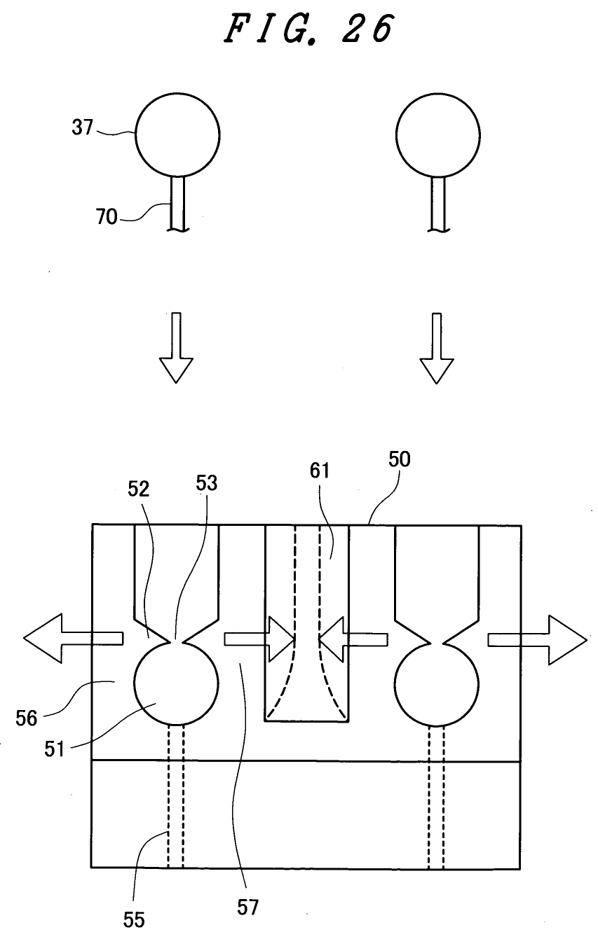

FIG. 26 is a schematic diagram showing a case where the second embodiment is applied to the connector 50 keeping hold of two pieces of fluorescent tubes 37. FIG. 26 is a front view of the connector 50. From above of the connector 50, the fluorescent tube 37 with a cable is inserted. The cable is inserted into the cable hole 55 of the connector 50, and the fluorescent tube 37 widens the tongue-like section 52 of the connector 50 toward the outside before being inserted into the insertion hole 51. At this time, because the notch 61 is formed to the internal wall 57 of the connector 50, the internal wall 57 is deformed with ease as indicated by a dotted line, thereby causing no intense stress to the fluorescent tube 37 and the cable.

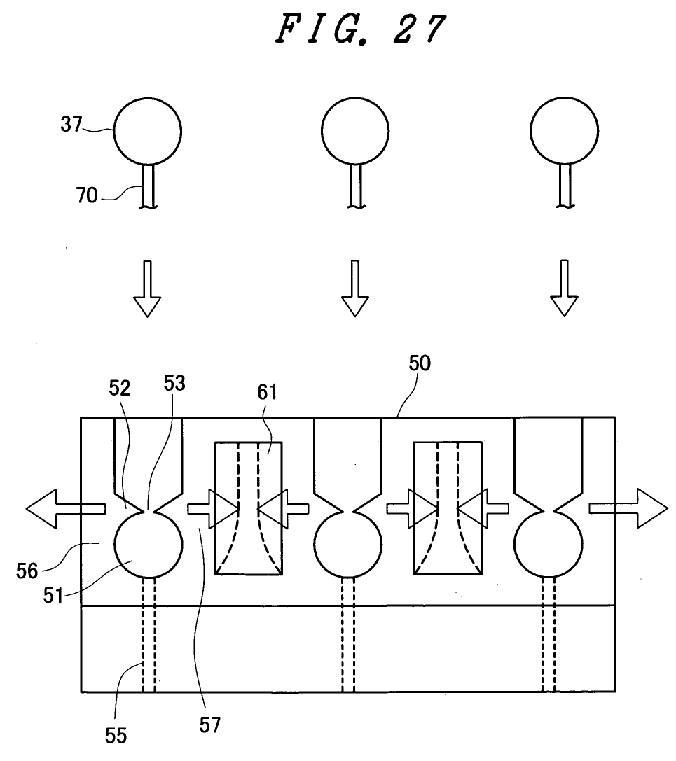

FIG. 27 is a schematic diagram showing a case where the second embodiment is applied to the connector 50 keeping hold of three pieces of fluorescent tubes 37. The process of inserting the fluorescent tubes 37 and the cables into the connector 50 is the same as that described by referring to FIG. 26. With the configuration that the connector 50 is not formed with the notch 61, for insertion of the fluorescent tube 37 into the insertion hole 51 in the middle, the fluorescent tube 37 is put under the large stress. In this embodiment, because the notch 61 is formed on both sides of the insertion hole 51 in the middle, similarly to the insertion hole 51 located on the outer sides, the fluorescent tube 37 and the cable can be inserted with ease into the insertion hole 51 located in the middle of the connector 50.

Also in a case where the connector 50 keeps hold of four or more pieces of fluorescent tubes 37, forming the notch 61 between the insertion holes 51 and 51 allows easy insertion of the fluorescent tubes 37 and the cables into the connector 50. By providing a plurality of connectors 50, any arbitrary number of fluorescent tubes 37 can be incorporated into a backlight. In this embodiment, a large number of fluorescent tubes 37 can be incorporated into the backlight with no damage and with efficiency. Moreover, the creepage distance can be set large between the terminals of any adjacent fluorescent tubes 37, and thus the reliability can be kept high in terms of voltage resistance.

What is claimed is:

1. A liquid crystal display device including a liquid crystal display panel, and a backlight provided with a plurality of fluorescent tubes and a connector that keeps hold of the fluorescent tubes at an end portion thereof, wherein
the connector is formed with insertion holes for keeping hold of the fluorescent tubes, and the insertion holes are each formed with a slit at an upper portion, and
a side wall is formed between any two of the insertion holes adjacent to each other, and the side wall is formed with a concave portion in an axial direction of the fluorescent tubes.

2. The liquid crystal display device according to claim 1, wherein
the connector is made of silicone resin.

3. The liquid crystal display device according to claim 1, wherein
the connector is formed with three or more of the insertion holes.

4. The liquid crystal display device according to claim 1, wherein
an outer shape of the concave portion is rectangular.

5. The liquid crystal display device according to claim 1, wherein
the concave portion has a depth equal to or deeper than a length of the slit in the axial direction of the fluorescent tubes.

6. The liquid crystal display device according to claim 1, wherein
the connector is provided plurally in line.

7. The liquid crystal display device according to claim 1, wherein
the fluorescent tubes are each provided with a terminal protruding in the axial direction thereof, and a cable connected with the terminal in a direction perpendicular to the axial direction, and the cable is inserted into a cable hole drilled through the connector.

8. The liquid crystal display device according to claim 7, wherein
the connector is made of silicone resin.

9. The liquid crystal display device according to claim 8, wherein
the connector is formed with three or more of the insertion holes.

10. A liquid crystal display device including a liquid crystal display panel, and a backlight provided with a plurality of fluorescent tubes and a connector that keeps hold of the fluorescent tubes at an end portion thereof, wherein
the connector is formed with insertion holes for keeping hold of the fluorescent tubes, and the insertion holes are each formed with a slit at an upper portion, and
a side wall is formed between any two of the insertion holes adjacent to each other, and the side wall is formed with a notch reaching an upper portion of the connector.

11. The liquid crystal display device according to claim 10, wherein
the connector is made of silicone resin.

12. The liquid crystal display device according to claim 10, wherein
the connector is formed with three or more of the insertion holes.

13. The liquid crystal display device according to claim 10, wherein
an outer shape of the notch is rectangular.

14. The liquid crystal display device according to claim 10, wherein
a depth of the notch in the axial direction of the fluorescent tubes is equal to or deeper than a length of the slit in the axial direction of the fluorescent tubes.

15. The liquid crystal display device according to claim 10, wherein
the connector is provided plurally in line.

16. The liquid crystal display device according to claim 10, wherein
the fluorescent tubes are each provided with a terminal protruding in the axial direction thereof, and a cable connected with the terminal in a direction perpendicular to the axial direction, and the cable is inserted into a cable hole drilled through the connector.

17. The liquid crystal display device according to claim 16, wherein
the connector is made of silicone resin.

18. The liquid crystal display device according to claim 16, wherein
the connector is formed with three or more of the insertion holes.

19. A liquid crystal display device including a liquid crystal display panel, and a backlight provided with a plurality of fluorescent tubes and a connector that keeps hold of the fluorescent tubes at an end portion thereof, wherein
the connector is formed with first and second insertion holes for keeping hold of the fluorescent tubes, and the first and second insertion holes are each formed with a slit at an upper portion, and
between the first and second insertion holes, there are a first side wall corresponding to the first insertion hole and a second side wall corresponding to the second insertion hole, and the first and second side walls are formed separately from each other at an upper portion.
